(19) United States
(12) Patent Application Publication
(10) Pub. No.: US 2020/0125599 A1
(43) Pub. Date: Apr. 23, 2020

(54) SEARCHING METHOD FOR PERSONAL OUTFIT RECORDING

(71) Applicant: CAL-COMP BIG DATA, INC., NEW TAIPE CITY (TW)

(72) Inventor: Hung-TAI HSU, NEW TAIPEI CITY (TW)

(21) Appl. No.: 16/387,028

(22) Filed: Apr. 17, 2019

(30) Foreign Application Priority Data
Oct. 17, 2018 (CN) 201811210774.1

(51) Int. Cl. G06F 16/58; G06F 16/538; G06F 16/535

(52) U.S. Cl. CPC G06F 16/5866; G06F 16/535; G06F 16/538

(57) ABSTRACT

A searching method for personal outfit recording adopted by an electronic device includes following steps: executing an application program by a processor of the electronic device; determining whether the electronic device obtains real-time information; determining whether the electronic device receives a searching keyword; regarding the real-time information and/or the searching keyword as a searching condition; performing a searching procedure based on at least the searching condition for obtaining outfit photographs that had been set with corresponding tags; each of the outfit photographs respectively contains a clothing image of a user; and, displaying the obtained outfit photographs through a display of the electronic device.

### BACKGROUND OF THE INVENTION

### 1. Technical Field

The technical field relates to a searching method, and specifically relates to a searching method for personal outfit recording which is adopted in an electronic device.

### 2. Description of Related Art

Recently, rapid fashionism is popular around the world, consumers are willing to purchase much more clothes, and change clothes for different outfits in accordance with different situations such as holidays, climates, moods, occasions, etc.

However, the consumers nowadays usually own too much clothes, it turns out that a lot of clothes will be left in the wardrobe by the consumers after being worn once, which causes a waste of the clothes.

Besides, there's no any system or method provided in the current market can assist the consumers to pick clothes and to decide what outfit to make according to the clothes the consumers had worn in the past. In conclusion, the above discussed problem has to be improved.

### SUMMARY OF THE INVENTION

The invention is directed to a searching method for personal outfit recording and/or a method for establishing a database of the personal outfit recording, which may search outfit photographs of the user recorded in the past according to the user's requirement, so as to assist the user to pick clothes and to decide what outfits to make according to the searched outfit photographs.

In one of the exemplary embodiments, the searching method of the present invention is adopted in an electronic device at least having a processor, an input unit and a display unit, and the searching method includes following steps: executing an application program by the processor of the electronic device; determining whether the electronic device receives real-time information by the application program; determining whether the electronic device receives a searching keyword inputted externally through the input unit by the application program; regarding the real-time information and/or the searching keyword as a searching condition of a searching procedure; performing the searching procedure to search and obtain one or more outfit photographs set with corresponding tags according to the searching condition, wherein each of the one or more outfit photographs searched by the searching procedure at least involves a clothing image; and displaying the one or more outfit photographs searched by the searching procedure on the display unit.

The present invention may obtain information such as time, location, climate, etc. by an electronic device and also obtain keywords inputted by a user such as cloth style, occasion, color, pattern, etc. for searching outfit photographs of the user that had been recorded in the past. In comparison with related arts, the present invention may help the user to recall the clothes he or she has and the outfits he or she had made, so as to assist the user to pick suitable clothes to wear.

### BRIEF DESCRIPTION OF THE DRAWINGS

FIG. 1 is a block diagram of an electronic device according to one embodiment of the present invention.

FIG. 2 is a flowchart of a photography establishing method according to one embodiment of the present invention.

FIG. 3 is a schematic diagram showing a photography establishment according to one embodiment of the present invention.

FIG. 4 is a flowchart of a photography searching method according to one embodiment of the present invention.

FIG. 5 is a flowchart of the photography searching method according to another embodiment of the present invention.

FIG. 6 is a schematic diagram showing a photography searching result according to one embodiment of the present invention.

### DETAILED DESCRIPTION OF THE INVENTION

The invention is directed to a method for automatically identifying users of body-fat meter, which can automatically identify user identity right after the measurement of the user is finished.

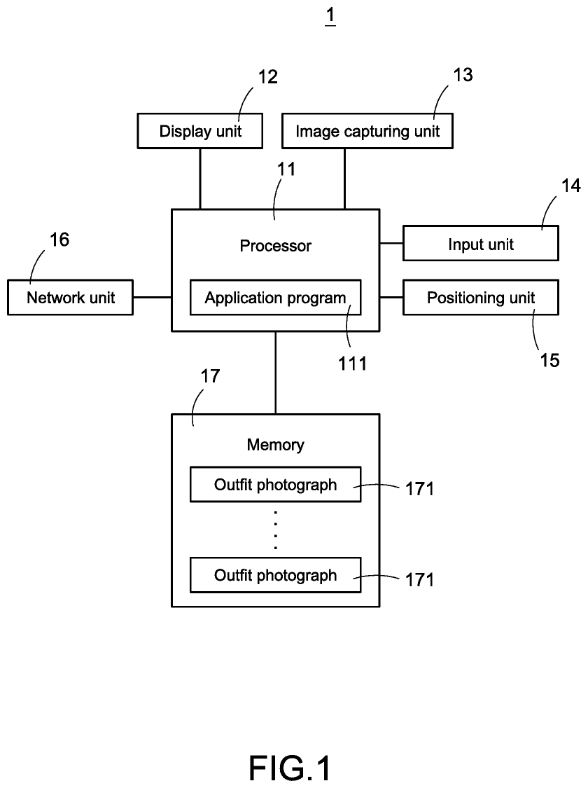

FIG. 1 is a block diagram of an electronic device according to one embodiment of the present invention. The present invention discloses a searching method for a user to search personal outfit recording (referred to as the searching method hereinafter), the searching method is mainly adopted by an electronic device 1 as shown in FIG. 1. In one embodiment, the electronic device 1 may be an intellectual mobile communication device, such as cellphone, tablet computer, laptop computer, etc. In another embodiment, the electronic device 1 may be a smart mirror device. The smart mirror device is, for example, an electronic mirror arranged with a processor, a camera and a touch screen, which can obtain and analyze user's image, so as to provide the user with assistances in skin maintenance, makeup, makeup removing and outfit according to the user's image.

For the sake of understanding, the searching method of the present invention will be discussed as being adopted by a mobile communication device in the following paragraphs, but not intended to narrow the claimed scope of the present invention.

As disclosed in FIG. 1, the electronic device 1 may include a processor 11, a display unit 12, an image capturing unit 13 and an input unit 14, wherein the display unit 12, the image capturing unit 13 and the input unit 14 are electronically connected with the processor 11. One of the technical features of the present invention is that the electronic device 1 may perform an image analysis on a cloth position of an image shot by the user and generates corresponding tag(s) thereon for the cloth position. After the electronic device 1 installs and executes an application program 111, a user may input keyword(s) to the electronic device 1 (i.e., input the keyword(s) through an interface (not shown) of the application program 111), the electronic device 1 may automatically search for photo(s) having the tag(s) corresponding to the keyword(s), so as to provide assistances to the user for picking clothes according to the searched photo(s). In the present invention, the searched photos are the photos that involve user's personal outfit recording and had been shot and stored in the past.

In one embodiment, the processor 11 is used to execute the application program 111, the display unit 12 is used to display a search result of the aforementioned application program 111. The search result can be, for example, one or more searched photos, i.e., one or more photos having the tags that are corresponding to the input keywords. The image capturing unit 13 is used to capture images according to external operations of the user and generate outfit photographs according to the captured images. The input unit 14 is used to provide an interface for the user to input the keywords for searching the outfit photographs. In this embodiment, the display unit 12 can be, for example, a monitor, a screen, a touch screen or a remote displayer. The image capturing unit 13 can be, for example, one or more cameras. The input unit 14 can be, for example, a keyboard, a mouse, a touch pad, a touch screen, a microphone or a gesture sensor, but not limited thereto.

As disclosed in FIG. 1, the electronic device 1 may further include a positioning unit 15, a network unit 16 and a memory 17, wherein the positioning unit 15, the network unit 16 and the memory 17 are electrically connected with the processor 11.

The positioning unit 15 may be a global positioning system (GPS) module, which is used for obtaining geographic information of the electronic device 1 such as the current country or the current location of the electronic device 1. The network unit 16 may be a network connecting module, such as Wi-Fi module, Bluetooth module or LTE module, which is used for the electronic device 1 to connect to communication network or Internet, so as to obtain related information such as current date, time, season, climate, etc. The memory 17 may be different kinds of storages, such as FLASH memory, hard-drive, etc., which is used for storing the outfit photographs 171 captured and generated by the image capturing unit 13. In another embodiment, the electronic device 1 may also store the outfit photographys 171 in a remote storage or a cloud database (not shown) after the outfit photographs 171 are shot and generated, not limited in a local memory 17 as disclosed in FIG. 1.

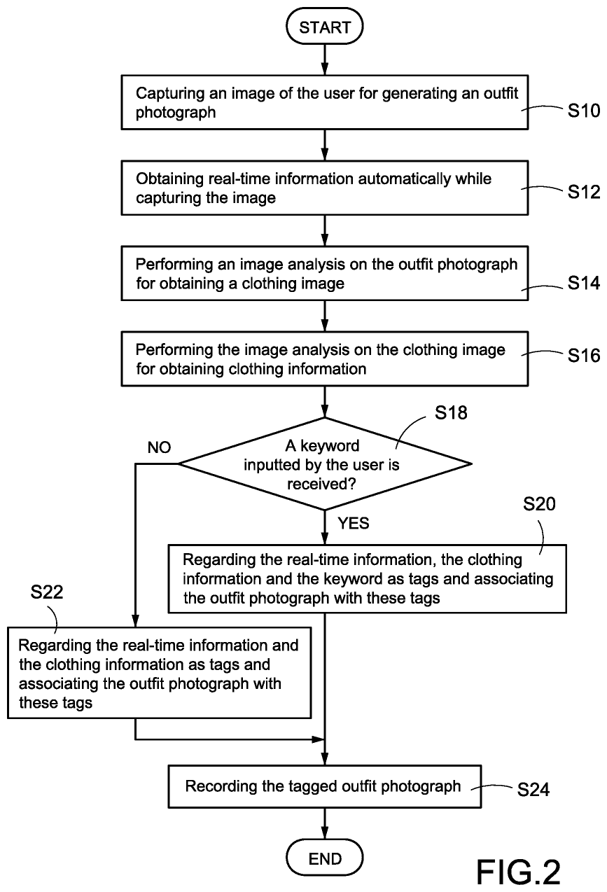

FIG. 2 is a flowchart of a photography establishing method according to one embodiment of the present invention. FIG. 2 is used to describe how the electronic device 1 generates the outfit photographs 171 that can be effectively searched by the searching method of the present invention.

First, a user may operate the electronic device 1, the electronic device 1 may capture an image of the user through the image capturing unit 13, so as to generate one of the outfit photographs 171 (step S10), wherein the electronic device 1 may perform an image analysis on the outfit photograph 171 through the application program 111, and establish tags which can be searched for the outfit photograph 171 (detailed described below).

After the step S10, the electronic device 1 may automatically obtain real-time information while capturing the image (step S12), and regards the real-time information as a foundation in establishing the aforementioned tags. In one embodiment, the electronic device 1 may obtain the real-time information through the positioning unit 15 and/or the network unit 16. The real-time information may be, for example, the current country, location, date, time, season, climate, etc. while the electronic device 1 capturing the image and generating the outfit photograph 171, but not limited thereto.

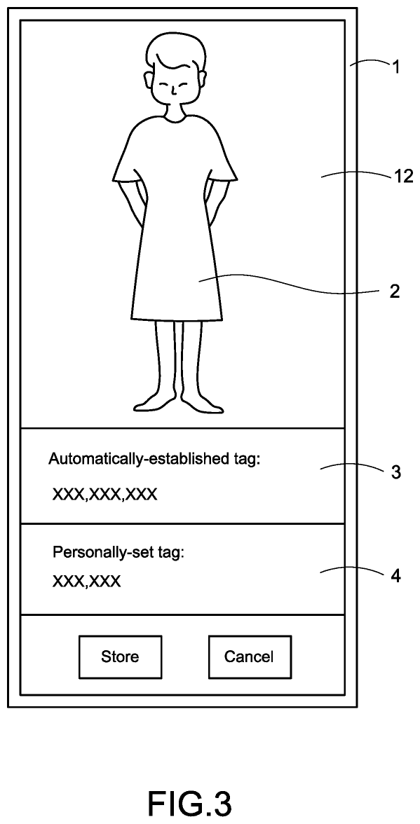

In the embodiment, the electronic device 1 may perform an image analysis on the outfit photograph 171 for obtaining a clothing image from the outfit photograph 171 (step S14). The clothing image here is a part of image of the outfit photograph 171 that involves the cloth wore by the user as shown in FIG. 3. The electronic device 1 further perform the image analysis on the clothing image for obtaining clothing information (step S16), therefore, the electronic device 1 may regard the clothing information as the foundation in establishing the aforementioned tags as well.

In the step S14 and the step S16, the electronic device 1 is mainly performing the image analysis through the execution of the application program 111, but not limited thereto. Besides, the aforementioned step S12 and S14 can be respectively executed according to an order. Alternatively, the step S12 and S14 can also be executed simultaneously.

In this embodiment, the clothing information records each message and parameter relative to the cloth wore by the user in the outfit photograph 171, which is obtained by the application program 111 after performing the image analysis on the clothing image. The clothing information may be, for example, cloth styles (such as long-sleeve, short-sleeve, coat, pants, skirt, dress, suit, shoes, etc.), color, pattern, logo, size, brand, etc., not limited thereto. In another embodiment, the application program 111 may identify each jewelry (such as earring or necklace) or accessory (such as hat, scarf or tie) co-existed with the clothes in the outfit photograph 171 through the image analysis, and regards the jewelry information and/or the accessory information as the foundation in establishing the aforementioned tags as well.

Next, the electronic device 1 determines (through the application program 111) whether receives a keyword inputted by the user through the input unit 14 (step S18), i.e., the electronic device 1 determines if the user has set an additional requirement for establishing the tags other than the aforementioned real-time information clothing information and jewelry information (and accessory information if exists).

If the electronic device 1 determines positive (YES) in the step S18 (i.e., the electronic device 1 does receive the keyword through the input unit 14), the electronic device 1 regards the real-time information, the clothing information (and the jewelry information/accessory information if exists) and the keyword as the tags of the outfit photograph 171, and associates the outfit photograph 171 with these tags (step S20). On the contrary, if the electronic device 1 determines negative (NO) in the step S18 (i.e., the electronic device 1 does not receive any keyword), the electronic device 1 directly regards the real-time information and the clothing information (and the jewelry information/accessory information if exists) as the tags of the outfit photograph 171, and associates the outfit photograph 171 with these tags (step S22).

In the present embodiment, the aforementioned keyword may be, for example, the current feeling of the user, the current occasion (such as a wedding), the special meaning of the cloth (such as a birthday gift), etc., not limited thereto.

Next, the electronic device 1 may record the outfit photograph 171 after the outfit photograph 171 has been associated with the tags (step S24). In particular, the electronic device 1 records the outfit photograph 171 after it is associated with the one or more tags (i.e., after the outfit photograph 171 has been tagged). In this embodiment, the electronic device 1 may store the outfit photograph 171 in the local memory 17, a remote storage or a cloud database. Since the outfit photograph 171 being stored has been associated with the one or more tags, a user may simply trigger the application program 111 of the electronic device 1 and input one or more keywords that are corresponding to the one or more tags through the input unit 14, and then the outfit photograph 171 can be quickly searched by the application program 111 according to the keywords. In a result, the user may check and recall the outfit back to the time the user takes the outfit photograph 171.

FIG. 3 is a schematic diagram showing a photography establishment according to one embodiment of the present invention. As shown in FIG. 3, after the aforementioned outfit photograph 171 has been shot by the image capturing unit 13, the electronic device 1 may perform a preview through the display unit 12, wherein the outfit photograph 171 at least involves a clothing image 2 of the user at the time the outfit photograph 171 has been shot.

In particular, the electronic device 1 may provide a graphic user interface (GUI) through the application program 111 for displaying the aforementioned outfit photograph 171. Also, the GUI may be used to display automatically-established tags 3 that are automatically generated by the application program 111 according to the real-time information and the clothing information, and also personally-set tags 4 that are manually set by the user through inputting the keywords. It is worth saying that the application program 111 may further provide an adjusting interface (not shown), whenever the user considers that part or all of the tags 3, 4 is wrong, he or she can adjust these tags 3, 4 or input new tag(s) through the adjusting interface. Therefore, the present invention may achieve the technical effect that assists the user in quickly and accurately establishing useful tags.

As shown in FIG. 3, a storing button is provided upon the GUI, once the storing button is triggered by the user, the application program 111 may automatically associate the outfit photograph 171 with the automatically-established tags 3 and the personally-set tags 4, and store the associated outfit photograph 171. Afterward, the user can easily search for this outfit photograph 171 by inputting one or more keywords that are corresponding to one or more of the automatically-established tags 3 and the personally-set tags 4.

By using the application program 111, the user may regularly perform selfies for preserving the outfit the user has made. When the user has a special requirement someday, he or she may search for the clothes or the outfits that he or she had made in the past by using the appropriate keywords, which is very convenient.

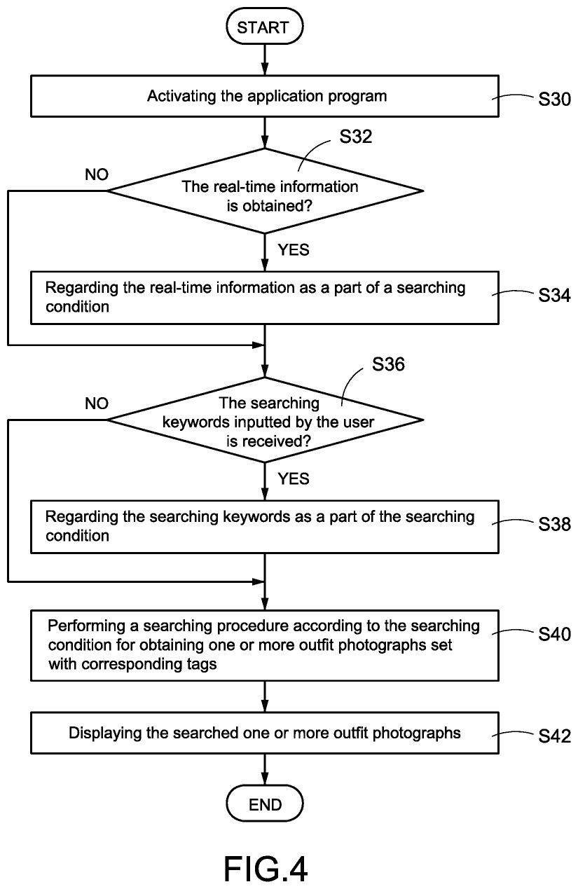

FIG. 4 is a flowchart of a photography searching method according to one embodiment of the present invention. FIG. 4 discloses each step of the searching method of the present invention. In particular, the searching method of the present invention is adopted by the electronic device 1 as shown in FIG. 1, and is used for searching the outfit photographs 171 generated and recorded by way of the approach disclosed in FIG. 2.

First, a user operates the electronic device 1 and activates the application program 111 (step S30). In the present invention, the application program 111 may have enough authority in accessing the one or more outfit photographs 171 from the memory 17, the remote storage or the cloud database.

In an embodiment, the application program 111 may receive searching keywords input by the user after being activated, so the application program 111 may search for one or more outfit photographs 171 (from the memory 17, the remote storage or the cloud database) according to the received searching keywords. Then, the application program 111 displays the one or more searched outfit photographs 171 for the user as a reference. In this scenario, the user may set the searching keywords based on current requirements, so as to obtain one or more outfit photographs 171 that are matched with the current requirements.

In particular, after being activated, the application program 111 determines whether the electronic device 1 automatically obtains the aforementioned real-time information (step S32), i.e., if the electronic device 1 automatically obtains the current country, location, date, time, season, climate, etc. of the electronic device 1 through the positioning unit 15 and the network unit 16. If the electronic device 1 effectively obtains the aforementioned real-time information, the application program 111 may regard the real-time information as a part of a searching condition (step S34).

For example, after the user activates the application program 111, the electronic device 1 automatically obtains different information like the current location (such as Beijing), date (such as Jul. 1, 2018), climate (such as hot), etc., wherein the climate may include detailed description about the weather, such as temperature, humidity, sunny, cloudy, rainy, snowy, gale, etc. Next, the application program 111 may use the information to search the memory 17 for obtaining the corresponding one or more outfit photographs 171. In the above example, the application program 111 may obtain, after searching, one or more outfit photographs 171 that were shot in Beijing at a hot July, therefore, the user may pick his or her clothes to wear and decide his or her outfit according to the obtained outfit photographs 171.

In the present invention, the application program 111 may further determine whether the electronic device 1 receives the searching keywords input by the user through the input unit 14 (step S36). In other words, the application program 111 determines if the user inputs specific requirements. In one embodiment, the searching keywords may be, for example, the cloth style, color, pattern, logo, size, brand, current feeling of the user, occasion to go, designated time, designated country, designated location, special meaning of the cloth, etc. If the electronic device 1 does receive the searching keywords input by the user, the application program 111 may regard these searching keywords as a part of the searching condition as well (step S38).

For example, if the user will go travelling to the US at Christmas, he or she may input the searching keywords including a designated time (such as December, Christmas, etc.), a designated country (such as the US) and an occasion (such as travelling), and the application program 111 may use these searching keywords to search the memory 17, so as to obtain corresponding one or more outfit photographs 171. In this example, the application program 111 may obtain, after searching, one or more outfit photographs 171 that were shot by the user while travelling to the US at a cold December in the past, and the user may take the searched outfit photographs 171 as references for preparing the clothes he or she can pick for the next travel.

After the searching condition (such as the real-time information and the searching keywords) is decided, the application program 111 may perform a searching procedure according to the searching condition (the searching procedure is performed to search the local memory 17, the remote storage or the cloud database), so as to obtain one or more outfit photographs 171 that had been set with corresponding tags (step S40), wherein each of the outfit photographs at least involves the aforementioned clothing image 2. Finally, the application program 111 may display the searched one or more outfit photographs 171 through the display unit 12 of the electronic device 1 (step S42).

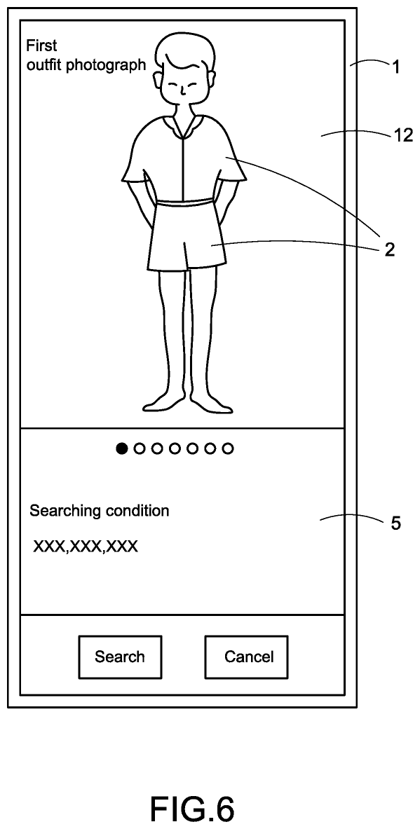

FIG. 6 is a schematic diagram showing a photography searching result according to one embodiment of the present invention. As shown in FIG. 6, the application program 111 may perform the searching procedure (in the memory 17, the remote storage or the cloud database) after obtaining the searching condition, so as to obtain and display one or more outfit photographs 171 that are matched with the searching condition. In the embodiment, each of the displayed outfit photographs 171 at least involves the clothing image 2 of the user.

In particular, the application program 111 may display the searched outfit photographs 171 through the aforementioned GUI. In an embodiment, the GUI may also display one or more searching conditions 5 being used by the application program 111 in performing the searching procedure through the GUI. As mentioned above, the searching condition may include the real-time information automatically obtained by the electronic device 1 itself and also the searching keywords manually inputted by the user.

It should be mentioned that if the user wants to adjust the searching condition 5 used by the application program 111, he or she may use an adjusting interface (not shown) provided by the application program 111 to adjust thereto.

As shown in FIG. 6, a search button is provided upon the GUI. After the user adjusts the searching condition 5 and presses the search button, the application program 111 may be triggered to re-perform the searching procedure according to the adjusted searching condition 5, and again displays the one or more outfit photographs 171 after the searching procedure is completed.

By using the searching method of the present invention, the user may use different parameters (such as time, location, climate, mood, pattern, etc.) to search the clothes or outfits he or she had made before, and regards the searched result (clothes and outfits) as a reference for the current/future outfits, which is very convenient.

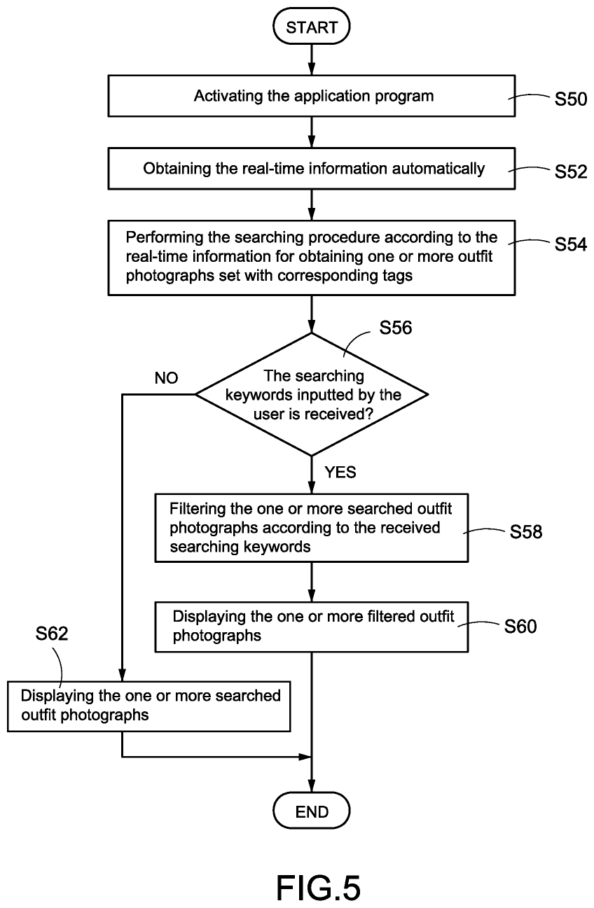

FIG. 5 is a flowchart of the photography searching method according to another embodiment of the present invention. FIG. 5 discloses another searching method similar to what is disclosed in FIG. 4. The difference between FIG. 4 and FIG. 5 is that the embodiment of FIG. 5 may be used for assisting the user in obtaining reference photos for the current clothes/outfits in a rapid searching speed.

In particular, the user activates the application program 111 of the electronic device 1 (step S50), the application program 111 may control the electronic device 1 to automatically obtain the aforementioned real-time information through the positioning unit 15 and the network unit 16 (step S52). Next, the application program 111 directly performs the searching procedure according to the real-time information for obtaining one or more outfit photographs 171 that had been set with corresponding tags (step S54). In other words, the one or more outfit photographs 171 being searched in the step S54 are respectively associated with one or more tags that are corresponding to the real-time information (such as country, location, date, etc.).

After the step S54, the application program 111 further determines whether the electronic device 1 receives searching keywords from the user through the input unit 14 (step S56). If the electronic device 1 does receive one or more searching keywords from the user, the application program 111 filters the one or more outfit photographs 171 searched in the step S54 according to the received searching keywords (step S58), and then displays the filtered one or more outfit photographs 171 (step S60). In other words, the one or more outfit photographs 171 being displayed in the step S60 are respectively associated with one or more tags that are corresponding to both the real-time information and the searching keywords.

If the electronic device 1 does not receive the searching keywords, the application program 111 may directly display the one or more outfit photographs 171 being searched in the step S54 (step S62). In other words, the one or more outfit photographs 171 being displayed in the step S62 are respectively associated with one or more tags that are corresponding to the real-time information.

By using the searching method shown in FIG. 5, the user may immediately obtain a searching result matched with the real-time information right after the application program 111 is activated upon the electronic device 1. Besides, the user may filter the searching result afterward by inputting the searching keywords, so as to obtain one or more outfit photographs 171 that are appropriate to the user's current requirement.

As discussed above, the present invention provides a fast and appropriate way for the user to recall the clothes he or she has and the outfits he or she had made in the past, so as to assist the user in picking the clothes to wear and deciding the current outfit to make.

As the skilled person will appreciate, various changes and modifications can be made to the described embodiment. It is intended to include all such variations, modifications and equivalents which fall within the scope of the present invention, as defined in the accompanying claims.

What is claimed is:

1. A method for searching personal outfit recording, adopted by an electronic device and comprising:
a) executing an application program by a processor of the electronic device;
b) determining whether receives a searching keyword externally inputted through an input unit of the electronic device by the application program;
c) regarding the searching keyword as a searching condition of a searching procedure if the searching keyword is received;
d) performing the searching procedure to search and obtain one or more outfit photographs set with corresponding tags according to the searching condition by the application program, wherein each of the one or more outfit photographs searched by the searching procedure at least comprises a clothing image; and
e) displaying the one or more outfit photographs searched by the searching procedure on a display unit of the electronic device.

2. The method for searching personal outfit recording in claim 1, wherein the searching condition comprises at least one of cloth style, color, pattern, logo, size, brand, mood, occasion, designated time, designated country, designated location and special meaning of the cloth.

3. The method for searching personal outfit recording in claim 1, further comprising following steps before the step c):
c01) determining whether the electronic device obtains real-time information automatically by the application program; and
c02) regarding the real-time information as a part of the searching condition if the real-time information has been obtained.

4. The method for searching personal outfit recording in claim 3, wherein the real-time information comprises at least one of current country, location, date, time, season and climate of the electronic device.

5. The method for searching personal outfit recording in claim 3, further comprising following step before the step c):
c03) performing the searching procedure to search and obtain the one or more outfit photographs set with corresponding tags according to the real-time information by the application program, wherein the step d) is to filter the obtained one or more outfit photographs according to the searching keyword for generating filtered one or more outfit photographs, and the step e) is to display the filtered one or more outfit photographs through the display unit.

6. The method for searching personal outfit recording in claim 3, wherein the electronic device is a mobile communication device, the mobile communication device comprises a positioning unit and a network unit electrically connected with the processor, wherein the step c01) is to automatically obtain the real-time information through the positioning unit and the network unit.

7. The method for searching personal outfit recording in claim 6, wherein the electronic device comprises a memory electrically connected with the processor, the one or more outfit photographs are stored in the memory.

8. The method for searching personal outfit recording in claim 3, further comprising following steps before the step a):
a01) obtaining an image of a user for establishing one of the outfit photographs through an image capturing unit of the electronic device;
a02) performing an image analysis on the established outfit photograph for obtaining the clothing image;
a03) performing the image analysis on the clothing image for obtaining clothing information;
a04) regarding the clothing information as a tag of the outfit photograph and associating the outfit photograph with the tag for generating a tagged outfit photograph; and
a05) storing the tagged outfit photograph.

9. The method for searching personal outfit recording in claim 8, further comprising following step before the step a04):
a06) obtaining the real-time information through a positioning unit and a network unit of the electronic device, wherein the step a04) is to regard both the clothing information and the real-time information as tags of the outfit photograph and associating the outfit photograph with the tags.

10. The method for searching personal outfit recording in claim 9, further comprising following step before the step a04):
a07) receiving a keyword inputted externally, wherein the step a04) is to regard the clothing information, the real-time information and the keyword as tags of the outfit photograph and associating the outfit photograph with the tags.
